(19) United States
(12) Patent Application Publication
(10) Pub. No.: US 2013/0320754 A1
(43) Pub. Date: Dec. 5, 2013

(54) POWER SUPPLY SYSTEM COMPRISING A MULTIPHASE MATRIX CONVERTER AND METHOD FOR OPERATING SAME

(71) Applicants: Ralf Edelbrock, Kiel (DE); Markus Pfeifer, Nurnberg (DE)

(72) Inventors: Ralf Edelbrock, Kiel (DE); Markus Pfeifer, Nurnberg (DE)

(21) Appl. No.: 13/984,091

(22) PCT Filed: Feb. 8, 2011
(86) PCT No.: PCT/EP2011/051789

§ 371 Date: Aug. 7, 2013

(51) Int. Cl. H02M 7/48; H02P 27/06; B60L 11/00

(52) U.S. Cl. CPC H02M 7/48; B60L 11/00; H02P 27/06
USPC 307/9.1; 363/71; 307/82; 318/722

(57) ABSTRACT

A power supply system having a multiphase matrix converter and a method for operating the system are proposed. The converter has a plurality of input and output terminals and a plurality of sub-converters. The input terminals are respectively connected to the output terminals via bidirectional switches of the sub-converters. A circuit has at latest one DC source, an inverter connected in series with the DC source to generator a first alternating voltage, and an HF transformer connected in series with the inverter and connected to each of the input terminals. The HF transformer transforms the first alternating voltage up into a second alternating voltage and changes the frequency of the second alternating voltage by a multiple as compared with frequency of the first alternating voltage. A control unit activates the bidirectional switches as a function of the second alternating voltage present on the output of the HF transformer.

### CROSS REFERENCE TO RELATED APPLICATIONS

This application is the US National Stage of International Application No. PCT/EP2011/051789 filed Feb. 8, 2011 and claims benefit thereof, the entire content of which is hereby incorporated herein by reference.

### FIELD OF INVENTION

The invention relates to a power supply system having a multiphase matrix converter comprising a plurality of input terminals, a plurality of output terminals and a plurality of sub-converters, wherein the input terminals are each connected to the output terminals via bidirectional switches of the sub-converters.

The invention also relates to a method for operating a power supply system having a multiphase matrix converter.

### BACKGROUND OF INVENTION

Such a power supply system with a multiphase matrix converter is disclosed in DE 20 2005 001 686 U1. Here the matrix converter is connected in a known manner to an alternating current system, such as for instance shown in FIG. 1. With such systems, expensive mains filters must be provided in the mains supply in order to reduce the harmonic components which negatively affect the degree of efficiency on account of their losses.

With power supply systems having photovoltaic systems as DC sources, the direct voltage must first be converted into a mains-synchronous alternating voltage in order to supply the power network, e.g. the 380 V network. Mains-driven inverters are used for this purpose.

Large photovoltaic arrays are subdivided into single strands. Here strand voltages up to 1,000 V are currently applied as an input voltage for a converter arranged downstream thereof. With such photovoltaic systems, this may result in unwanted vibration behavior on account of the fluctuating load stored in the system capacitances distributed across the photovoltaic array.

In order to prevent this problem and other disadvantages of this embodiment, a plurality of strands of a photovoltaic field is connected in parallel and the power is fed to a central inverter by way of larger cable cross-sections. A plurality of such inverters is connected to the mains by way of a medium-voltage or high-voltage transformer.

### SUMMARY OF INVENTION

The object underlying the invention is therefore to propose a power supply system of the type described above and a method for operating such a power supply system, which provides for power to be fed from several DC sources, e.g. from a photovoltaic array, in order to supply three-phase current consumers in a simple manner.

The object is achieved on the one hand by a power supply system having the features as claimed in the first independent claim. A circuit is connected in this case to the input terminals in each instance, said circuit comprising at least one DC source, an inverter connected in series herewith in order to generate a first alternating voltage and a HF transformer connected in series with the inverter. The HF transformer is used to convert the first alternating voltage into a second alternating voltage and to change the frequency of the second alternating voltage by a multiple as compared with the frequency of the first alternating voltage. Furthermore, a control unit is provided, which activates the bidirectional switches of the multiphase matrix converter and the HF transformer as a function of the momentary values of current and voltage at the output of the DC sources and as a function of the second alternating voltage present at the output of the HF transformer.

The further object relating to the method is achieved with the features as claimed in the second independent claim. Here the sinusoidal alternating voltages present at the output terminals for the phases of the three-phase system are formed by voltage pulses with a different duration and level from the alternating voltages present at the outputs of the HF transformer, by the control unit activating the bidirectional switches such that the voltage pulses are routed to the output terminals. Here the duration and level of the voltage pulses routed therethrough are changed by the control unit as required.

Advantageous developments of the invention are inferred from the dependent claims.

An advantageous development of the invention exists if the DC sources are embodied as regions of a photovoltaic array.

It is furthermore advantageous if control is effected by the control unit as a function of active and/or reactive power specifications, e.g. of a system operator.

One particular advantage exists if sinusoidal alternating voltages for the phases of a three-phase system are present at the output terminals, said alternating voltages being formed by voltage pulses with a different duration and level and which, triggered by the control unit, are routed from the bidirectional switches to the output terminals of the multiphase matrix converter, wherein the duration and level of the voltage pulses routed therethrough can be changed by the control unit.

According to the claims the power supply system is used to drive a battery-operated vehicle, wherein the DC source is embodied as a battery.

The developments of the inventive method correspond to the advantageous embodiments of the inventive power supply system.

### BRIEF DESCRIPTION OF DRAWINGS

One exemplary embodiment of the invention is described in more detail with the aid of a drawing, in which:

FIG. 1 shows a circuit topology of a power supply system known from the prior art having a matrix converter,

FIG. 2 shows the circuit topology of an inventive power supply system having a multiphase matrix converter,

FIG. 3 shows a half wave of a sinusoidal alternating voltage formed from a plurality of voltage blocks and

FIG. 4 shows a voltage block formed from a plurality of voltage pulses.

### DETAILED DESCRIPTION OF INVENTION

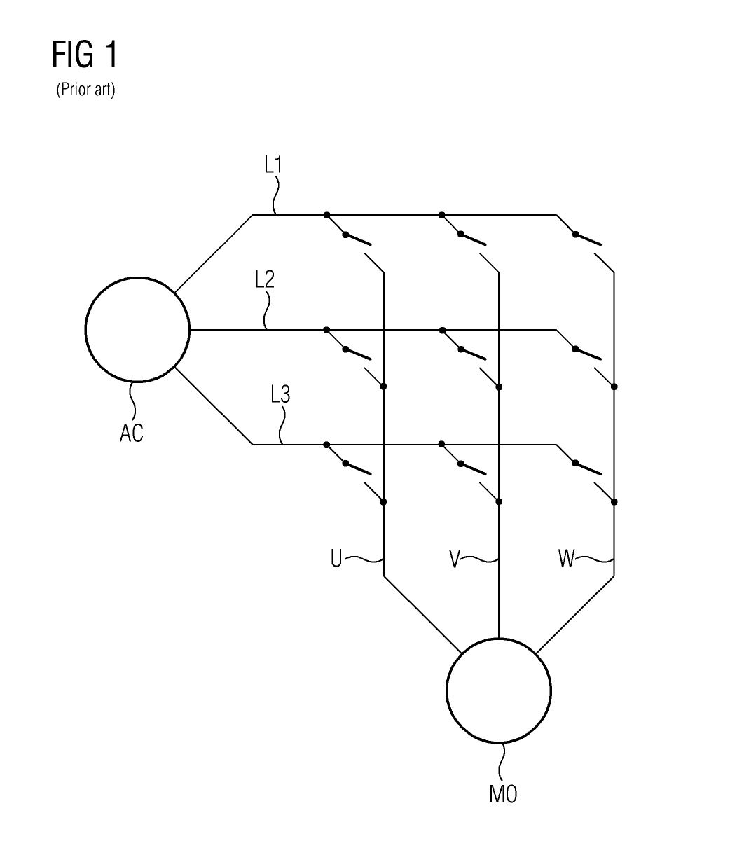

FIG. 1 shows a circuit topology of a power supply system with a matrix converter known from the prior art, wherein a three-phase system AC is connected to the input side of the matrix converter by way of lines L1, L2, L3 and the output terminals are connected to a motor MO. Here the matrix converter is shown simplified with switching elements, which, in reality, are embodied as bidirectional switches.

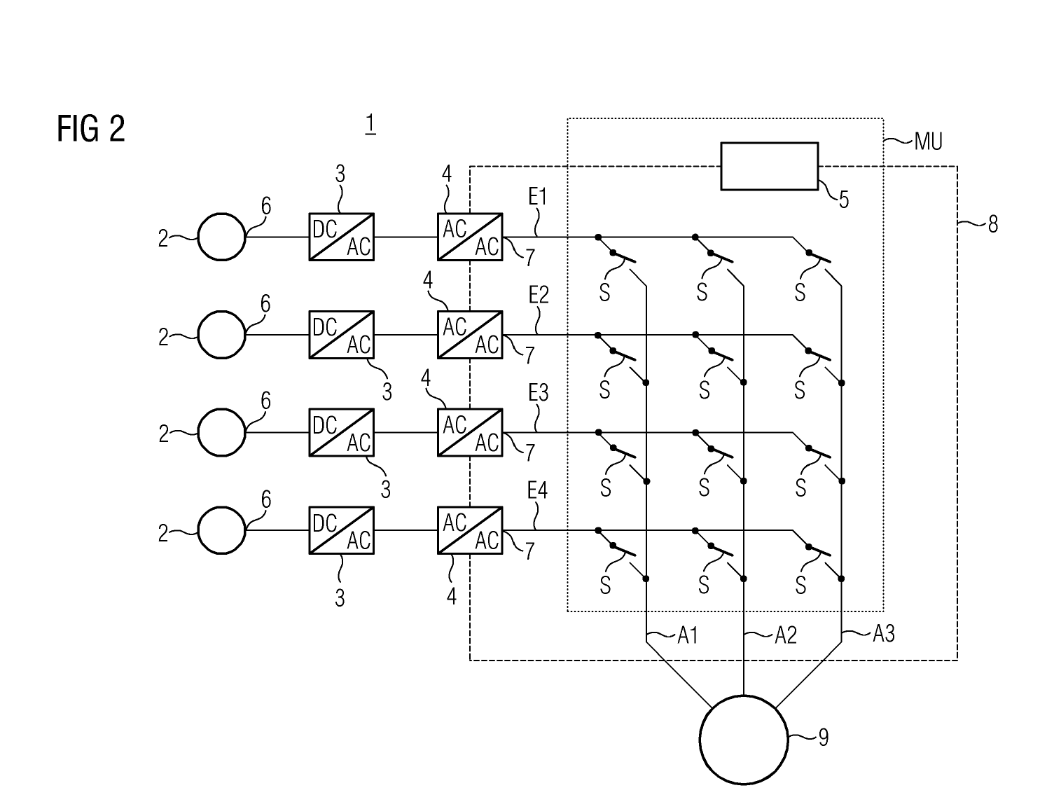

FIG. 2 shows an inventive power supply system 1 having a multiphase matrix converter MU, which comprises a plurality of input terminals E1, E2, E3, E4, a plurality of output terminals A1, A2, A3 and a plurality of sub-converters. The input terminals E1, E2, E3 and D4 are each connected to the output terminals A1, A2, A3 via bidirectional switches S of the sub-convertors, said output terminals being connected here to a public network.

A circuit is connected in each instance to the input terminals E1, E2, E3, E4, each circuit comprising at least one DC source 2, an inverter 3 connected in series herewith for generating a first alternating voltage, here a rectangular voltage, and an HF transformer 4 connected in series with the inverter 3. The inverter 3 is embodied with a local, autonomous MPP tracking, wherein MPP stands for Maximum Power Point. The HF transformer 4 is used to transform the first alternating voltage up into a second alternating voltage and to increase the frequency of the second alternating voltage by a multiple as compared with the frequency of the first alternating voltage. The multiphase matrix converter MU includes a control unit 5, which actuates the bidirectional switch S of the multiphase matrix converter MU as a function of the second alternating voltage present at the output 7 of the HF transformer. To this end, the control unit 5 is connected to the HF transformers 4 by way of a communication line 8. If necessary, current and voltage are transmitted to the control unit 5 at the output 6 of the DC sources 2.

The HF transformer 4 obtains the target values for the pulse shape by way of the control unit 5, said pulse shape being generated in a local control loop in the HF transformer 4. In the multiphase matrix converter MU, measuring points exist for all second alternating voltages at the output of the HF transformer 4, said measuring points providing the momentary voltage values to the control unit 5. If the target values deviate here from the values measured in the multiphase matrix converter MU, parameters are adjusted in the control unit 5. This may be necessary for instance in the case of large cable lengths between the HF transformer 4 and the multiphase matrix converter MU.

When such a power supply system 1 is used to feed the power provided by a photovoltaic array into a public grid 9, individual regions of the photovoltaic array are used as DC sources 2. Here any number of DC sources 2 can be used.

A number of individual strands of the photovoltaic array which are connected in parallel can be used as DC sources 2. Furthermore, a plurality of inverters 3 can also supply the downstream HF transformer 4.

The sinusoidal alternating voltages for the phases of the three-phase system 9 are formed here by voltage pulses with a different duration and level, which, triggered by the control unit 5, are routed from the bidirectional switches S to the output terminals A1, A2, A3 of the multiphase matrix converter MU. The duration and level of the voltage pulses routed therethrough can be changed by the control unit 5.

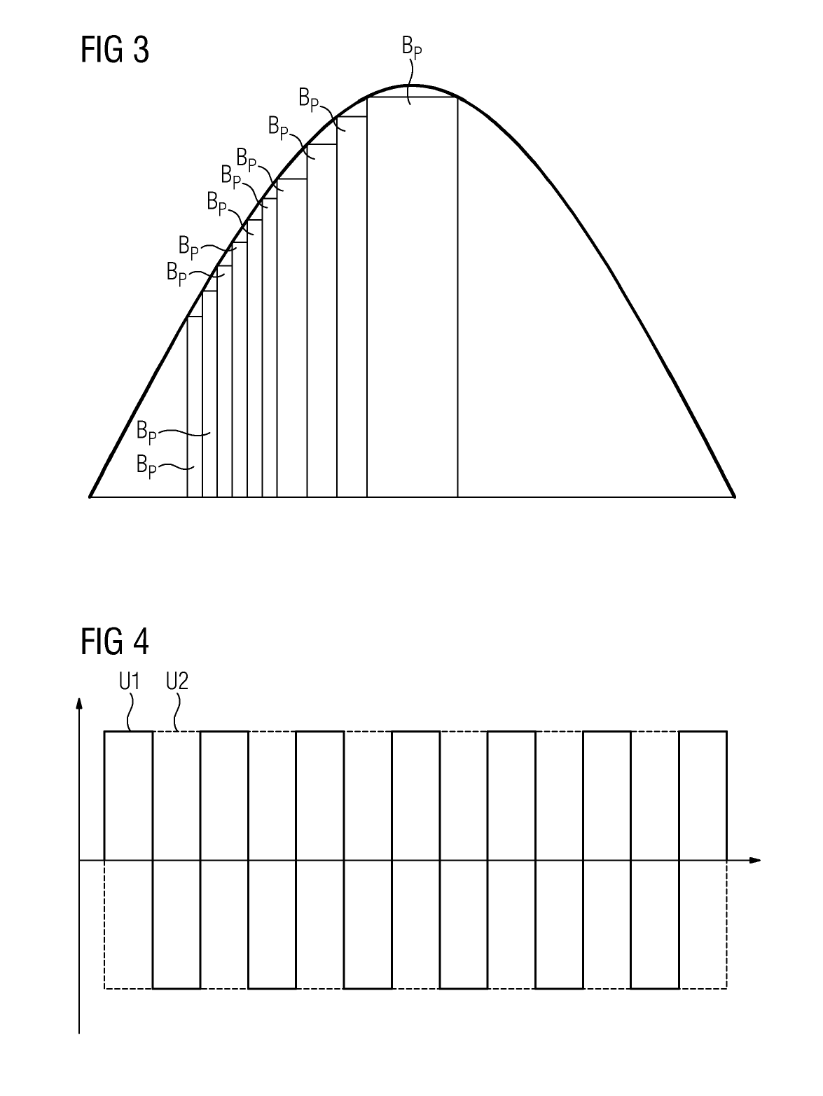

This is explained by way of example with the aid of FIG. 3 and FIG. 4. FIG. 3 shows in principle how a section of a positive sine half wave of an alternating voltage can be reproduced by positive voltage blocks Bp with a different height and width. These voltage blocks Bp for the positive sine half wave are composed, according to FIG. 4 for instance of the positive individual pulses of two square-wave voltages U1 and U2, which have the same amplitude and frequency, but are phase-shifted by 180 degrees, wherein the two square-wave voltages are generated by two HF transformers 4.

When a strand in a photovoltaic field is switched off, the control unit 5 can generate a new suitable pulse pattern by means of an adaptive algorithm and distribute the same to all converters, so that the multiphase matrix converter MU can operate in the optimal range.

The active and/or reactive power output to the grid can be controlled by the control unit 5 by way of the multiphase matrix converter MU in accordance with the specifications of the system operator. Specifications as to the grid quality, e.g. to the harmonic content, can be converted by the control unit 5 by means of a corresponding controller.

The power supply system 1 according to FIG. 2 can advantageously also be used to drive a battery-operated vehicle. The batteries are used here as DC sources and an electric motor is connected to the output terminals A1, A2, A3 of the multiphase matrix converter MU. The HF transformer 4 and the multiphase matrix converter MU are encapsulated in a common housing as a module, said module forming protection against contact from system parts with a high voltage.

An electric disconnection point is provided between each battery and the HF transformer 4 which is connected in series therewith, said disconnection point being opened by the control unit 5 after measuring a high acceleration value caused by accident. The electric disconnection point may be embodied for instance as an electromechanical or electronic switch.

A change in the DC voltage at the output of a DC source 2 or the complete failure of the same, which results in a change in the amplitude of the second alternating voltage at the output of the downstream HF transformer 4, is compensated for by adjusted control of the HF transformer 4 and of the multiphase matrix converter MU.

1.-13. (canceled)

14. A power supply system, comprising:
a multiphase matrix converter;
an input terminal;
an output terminal;
a sub-converter;
a DC source;
an inverter connected with the DC source to generate a first alternating voltage;
an HF transformer connected with the inverter and the input terminal; and
a control unit,
wherein the input terminal is connected to the output terminal via a bidirectional switch of the sub-converter;
wherein the HF transformer transforms the first alternating voltage up into a second alternating voltage and changes a frequency of the second alternating voltage by a multiple as compared with a frequency of the first alternating voltage; and
wherein the control unit activates the bidirectional switch as a function of the second alternating voltage present at an output of the HF transformer.

15. The power supply system as claimed in claim 14, further comprising a plurality of input terminals, a plurality of output terminals, a plurality of sub-converters, and a plurality of DC sources, wherein the input terminals each connected to the output terminals via a plurality of bidirectional switches of the sub-converters, and wherein the DC sources are embodied as regions of a photovoltaic array.

16. The power supply system as claimed in claim 14, wherein the control unit activates the bidirectional switch as a function of an active and/or reactive power specification.

17. The power supply system as claimed in claim 14, wherein the control unit activates the bidirectional switches as a function of a system operator

18. The power supply system as claimed in claim 14, wherein sinusoidal alternating voltages for phases of a three-phase system are present at the output terminal, wherein the phases are formed by voltage pulses with a different duration and level and triggered by the control unit and routed from the multiphase matrix converter, wherein the duration and the level of the voltage pulses routed therethrough can be changed by the control unit.

19. The power supply system as claimed in claim 14, wherein the power supply system is used to drive a battery-operated vehicle.

20. The power supply system as claimed in claim 14, wherein the DC source is embodied as a battery.

21. The power supply system as claimed in claim 14, wherein an electric motor is connected to the output terminal of the multiphase matrix converter.

22. The power supply system as claimed in claim 14, wherein the HF transformer and the multiphase matrix converter are encapsulated in a shared housing as a module.

23. The power supply system as claimed in claim 20, wherein an electric disconnection point is provided between the battery and the HF transformer connected thereto.

24. A method for operating a power supply system, comprising:
connecting an input terminal to an output terminal via a bidirectional switch of a sub-converter;
generating a first alternating voltage by an inverter connected with a DC source;
connecting an HF transformer with the inverter and the input terminal;
transforming the first alternating voltage up into a second alternating voltage and changing a frequency of the second alternating voltage by a multiple as compared with a frequency of the first alternating voltage by wherein the HF transformer; and
activating the bidirectional switch as a function of the second alternating voltage present at an output of the HF transformer by a control unit,
wherein sinusoidal alternating voltages present at the output terminal for phases of the three-phase system are formed by voltage pulses of a different duration and height from the second alternating voltage present at the output of the HF transformer,
wherein the control unit actuates the bidirectional switch such that the voltage pulses are routed to the output terminal, and
wherein the duration and the height of the voltage pulses routed therethrough are changed by the control unit.

25. The method as claimed in claim 24, wherein when a DC voltage is changed at an output of the DC source which results in a change in amplitude of the second alternating voltage at the output of the HF transformer, the amplitude is compensated for by adjusted control of the HF transformer and the bidirectional switch.

26. The method as claimed in claim 24, wherein electrical disconnection points are opened by the control unit after measuring a high acceleration value caused by an accident.

27. The method as claimed in claim 24, wherein the power supply system is used to drive a battery-operated vehicle, wherein the DC source is a battery, and wherein upon failure of the battery, an electric motor is operated with a reduced energy supply by other batteries in the vehicle.
